(19) United States
(12) Patent Application Publication
(10) Pub. No.: US 2012/0257027 A1
(43) Pub. Date: Oct. 11, 2012

(54) Stereoscopic Image Display Apparatus, Image Display System and Method for Displaying Stereoscopic Image

(75) Inventor: Kunihiko Kawahara, Hamura-shi (JP)

(73) Assignee: KABUSHIKI KAISHA TOSHIBA

(21) Appl. No.: 13/528,699

(22) Filed: Jun. 20, 2012

Related U.S. Application Data
(63) Continuation of application No. 12/264,013, filed on Nov. 3, 2008.

(30) Foreign Application Priority Data
Mar. 24, 2008 (JP) 2008-076286

(51) Int. Cl. H04N 13/04

(52) U.S. Cl. 348/56; 348/E13.001

(57) ABSTRACT

A stereoscopic image display apparatus includes: a liquid crystal display device that alternately displays a left-eye image in a first time frame and a right-eye image in a second time frame, the left-eye image and the right-eye image being images to be respectively viewed by left and right eyes of a viewer; and an LCD shutter glasses that includes: a left-eye shutter that covers the left eye of the viewer during the second time frame; and a right-eye shutter that covers the right eye of the viewer during the first time frame, wherein the liquid crystal display device sequentially displays a first left-eye image frame and a second left-eye image frame included in the left-eye image during the first time frame and sequentially displays a first right-eye image frame and a second right-eye image frame included in the right-eye image during the second time frame.

### CROSS REFERENCE TO RELATED APPLICATION(S)

The present disclosure is a continuation application that is based upon and claims priority to U.S. application Ser. No. 12/264,013, now abandoned, which relates to the subject matters contained Japanese Patent Application No. 2008-076286 filed on Mar. 24, 2008, which are incorporated herein by reference in its entirety.

### FIELD

The present invention relates to a stereoscopic image display apparatus, which is equipped with a liquid crystal display device alternately displaying a left-eye image and a right-eye image by time division and an LCD shutter glasses having a left-eye shutter and a right-eye shutter that are alternately activated, a method for displaying stereoscopic image, and an image display system used in the apparatus and the method.

### BACKGROUND

There is proposed a technique for displaying a stereoscopic image to a user in which alternately displaying a left-eye image and a right-eye image in each time-divided time frames by a CRT display. The user wears LCD shutter glasses having a left-eye shutter and a right-eye shutter that are alternately activated for the left eye and the right eye, respectively.

An example of such technique is disclosed in JP-2000-004450-A. In the technique disclosed in this publication, a left-eye image and a right-eye image having parallax are displayed alternately by time division (in time frames) and the left-eye image and the right-eye image are selectively be viewed by the left eye and the right eye of the user. A non-visible state is established in a latter portion of each time frame, the latter portion being a given period T of each time frame (from a given intermediate time to the end of the time frame), whereby a contrast ratio of an image to be visually recognized in a time frame concerned to an afterimage of an immediately preceding time frame is increased and a flicker due to afterimages of the image display device is reduced.

Liquid crystal display devices, which are lighter and smaller in installation area than CRT displays, have been extensively used as display devices for displaying images. However, if the technique disclosed in the aforementioned publication is applied to a system that uses a liquid crystal display device, an image mixed with a left-eye image and a right-eye image is displayed to the user instead of a stereoscopic image to be displayed. Therefore, a technique is desired which appropriately displays a stereoscopic image to a user when a liquid crystal display device is used.

### BRIEF DESCRIPTION OF THE DRAWINGS

A general configuration that implements the various feature of the invention will be described with reference to the drawings. The drawings and the associated descriptions are provided to illustrate embodiments of the invention and not to limit the scope of the invention.

FIG. 1 illustrates the configuration of a stereoscopic image display apparatus according to a first embodiment, showing a state that a liquid crystal shutter L is closed.

FIG. 2 illustrates the configuration of the stereoscopic image display apparatus according to the first embodiment, showing a state that a liquid crystal shutter R is closed.

FIG. 3 is a timing chart showing frame data and several control signals.

FIG. 4 illustrates a method for outputting image for a liquid crystal display device.

FIG. 5 is a timing chart corresponding to FIG. 4.

FIG. 6 shows a problem that arises when a liquid crystal display device displays a stereoscopic image according to a conventional method.

FIG. 7 is a timing chart showing frame data and a liquid shutter control method according to the first embodiment.

FIG. 8 is a timing chart showing frame data and a liquid shutter control method according to a second embodiment.

### DETAILED DESCRIPTION OF THE EMBODIMENTS

Hereinafter, embodiments of the invention will be described. In the following description, the same or similar components will be referenced by the same reference numerals, and detailed description thereof will be omitted.

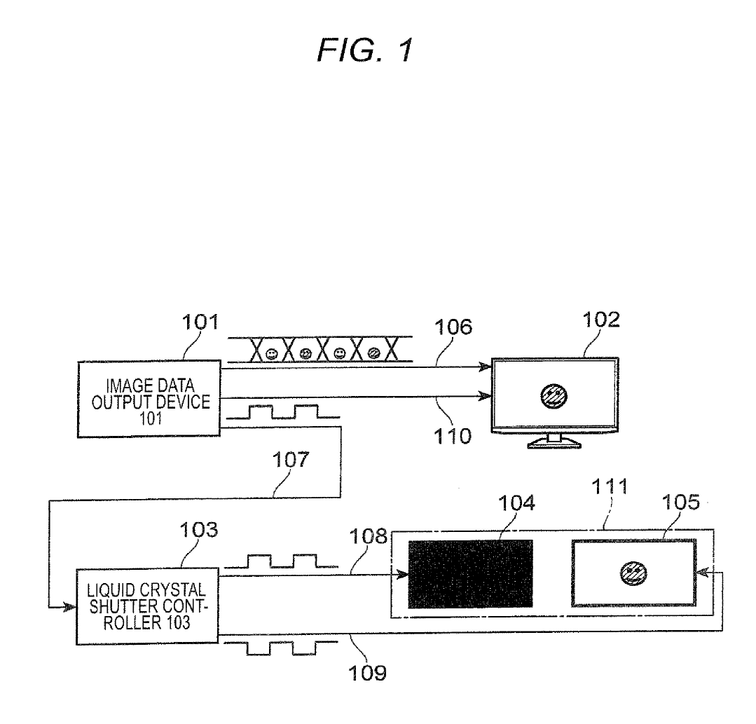

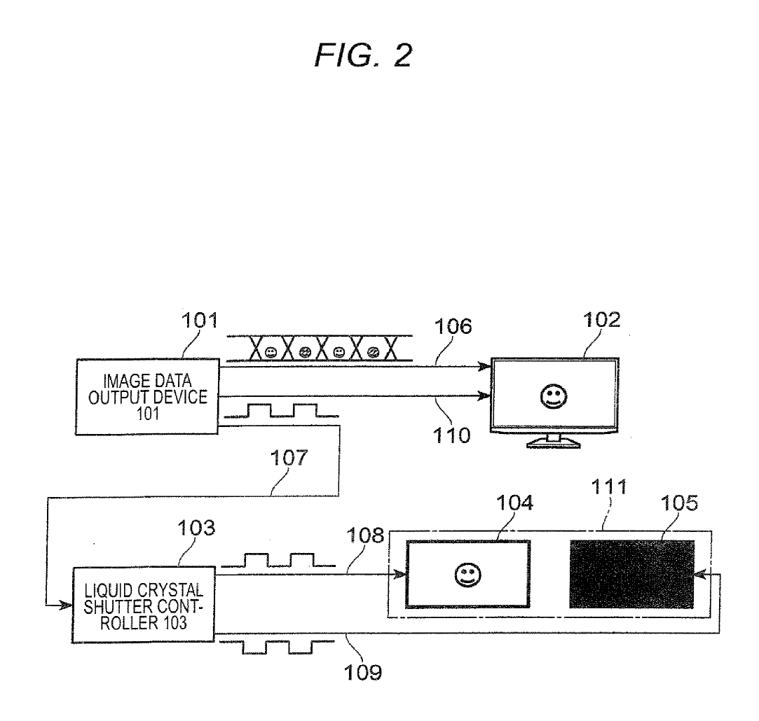

FIGS. 1 and 2 illustrate the configuration of a stereoscopic image display apparatus according to a first embodiment. FIGS. 1 and 2 show a state that a liquid crystal shutter L is closed and a state that a liquid crystal shutter R is closed, respectively. In the stereoscopic image display apparatus according to the first embodiment, a liquid crystal display device displays a left-eye image and a right-eye image alternately by time division (in time frames). A user wears LCD shutter glasses having a left-eye shutter and a right-eye shutter that are opened or closed for the left eye and the right eye, respectively. A stereoscopic image is thereby displayed and be viewable to the user.

As shown in FIGS. 1 and 2, the stereoscopic image display apparatus according to the embodiment is equipped with an image data output device (image processor) 101, a liquid crystal display device 102, a liquid crystal shutter controller 103, and an LCD shutter glasses 111. The LCD shutter glasses 111 have a liquid crystal shutter L (left-eye shutter) 104 and a liquid crystal shutter R (right-eye shutter) 105.

The image data output device 101 is a device for sending, to the liquid crystal display device 102, frame data 106 for image output from the liquid crystal display device 102. In the embodiment, the image data output device 101 sends out left-eye image data and right-eye image data alternately in each of time frames for a left-eye image and time frames for a right-eye image. As described later, each left-eye image data includes data for display of a first left-eye frame and a second left-eye frame and each right-eye image data includes data for display of a first right-eye frame and a second right-eye frame.

To prevent a flicker of an image to be displayed on the liquid crystal display device 102, first left-eye frames, second left-eye frames, first right-eye frames, and second right-eye frames (frames of each kind) are displayed on the liquid crystal display device 102 at a rate of 60 frames/sec or more, even preferably, 120 frames/sec or more.

The image data output device 101 also outputs, to the liquid crystal shutter controller 103, a frame control signal 107 which indicates a frame status. The image data output device 101 sends, to the liquid crystal display device 102, a backlight control signal 110 for controlling the lighting of the backlight of the liquid crystal display device 102.

The liquid crystal display device 102 is a device that displays the frame data input from the image data output device 101 as an image.

The liquid crystal shutter controller 103 controls the opening/closing of the liquid crystal shutter L 104 and the liquid crystal shutter R 105 using a liquid crystal shutter L control signal 108 and a liquid crystal shutter R control signal 109, respectively. FIG. 1 shows a state that the liquid crystal shutter L 104 is closed and the liquid crystal shutter R 105 is open. On the other hand, FIG. 2 shows a state that the liquid crystal shutter L 104 is open and the liquid crystal shutter R 105 is closed.

The liquid crystal shutter L 104 of the LCD shutter glasses 111 serves as a left-hand lens of the LCD shutter glasses 111. The left eye of the user can see an image displayed on the liquid crystal display device 102 while the liquid crystal shutter L 104 is open, but cannot see anything while the liquid crystal shutter L 104 is closed.

The liquid crystal shutter R 105 of the LCD shutter glasses 111 serves as a right-hand lens of the LCD shutter glasses 111. The right eye of the user can see an image displayed on the liquid crystal display device 102 while the liquid crystal shutter R 105 is open, but cannot see anything while the liquid crystal shutter R 105 is closed.

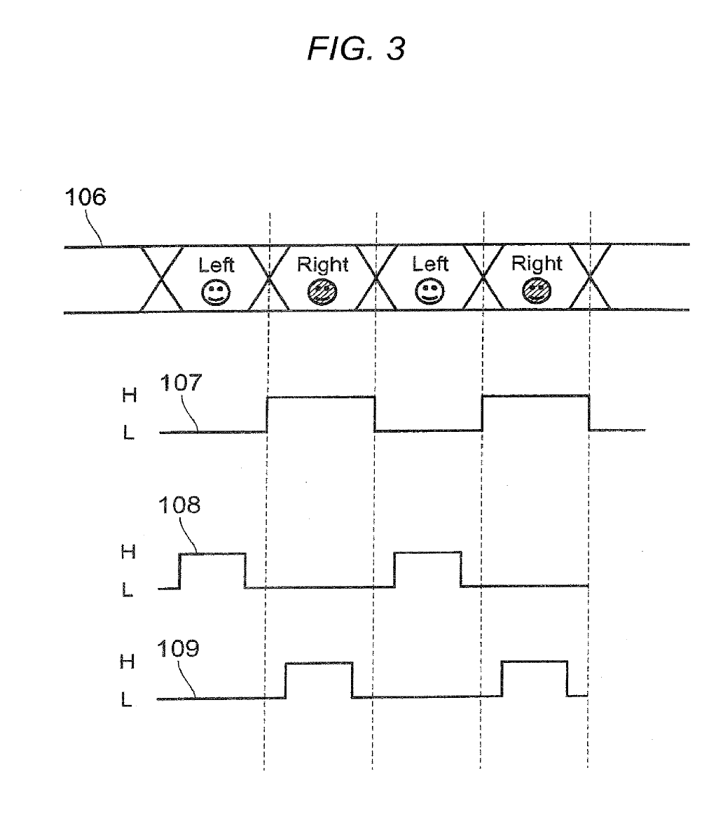

FIG. 3 is a timing chart showing frame data and several control signals. The frame data 106 are image data that are supplied to the liquid crystal display device 102. In the embodiment, the image data output device 101 sends out left-eye image data and right-eye image data alternately. Although as described later each left-eye image data and each right-eye image data consist of two frame data, FIG. 3 schematically shows left-eye image data and right-eye image data.

The frame control signal 107 indicates the status of the frame data 106. In the embodiment, as shown in FIG. 3, the image data output device 101 outputs a low-level frame control signal 107 in outputting left-eye frame data and outputs a high-level frame control signal 107 in outputting right-eye frame data.

The liquid crystal shutter L control signal 108 is a signal for controlling the opening/closing of the liquid crystal shutter L 104. The liquid crystal shutter R control signal 109 is a signal for controlling the opening/closing of the liquid crystal shutter R 105. The patterns of these signals will be described later.

The backlight control signal 110 is a signal for controlling the backlight of the liquid crystal display device 102. That backlight is turned on while the backlight control signal 110 is at high level, and the backlight is turned off while the backlight control signal 110 is at low level. In the embodiment, while the liquid crystal display device 102 is in use, the backlight should be kept on and hence the image data output device 101 continues to output a high-level backlight control signal 110.

The stereoscopic image display apparatus according to the embodiment can be implemented by using a personal computer. In this case, the image data output device 101 is the personal computer, the liquid crystal display device 102 is a liquid crystal monitor, and the liquid crystal shutter controller 103 is an external device. In this case, a user can view 3D CAD (computer-aided design) data etc. However, attention should be paid to the fact that common liquid crystal monitors employ a frame rate of 60 Hz.

On the other hand, the stereoscopic image display apparatus according to the embodiment can also be implemented by using a liquid crystal TV receiver. In this case, the image data output device 101 is a video output section inside the liquid crystal TV receiver, the liquid crystal display device 102 is a liquid crystal panel of the liquid crystal TV receiver, and the liquid crystal shutter controller 103 is an external device. In this case, stereoscopic image viewing software can be utilized by use of a home TV receiver.

The operation of the stereoscopic image display apparatus according to the embodiment will be described below. In the embodiment, the image data output device 101 outputs frame data 106 and a frame control signal 107. The image data output device 101 sends out, as the frame data 106, left-eye image data and right-eye image data alternately in each of time frames for a left-eye image and time frames for a right-eye image. The liquid crystal display device 102 receives the frame data 106 and displays an image.

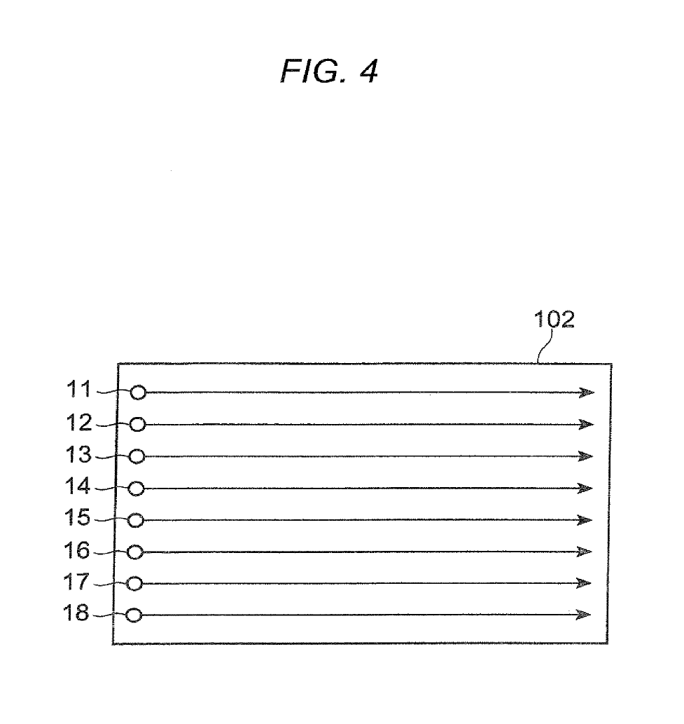

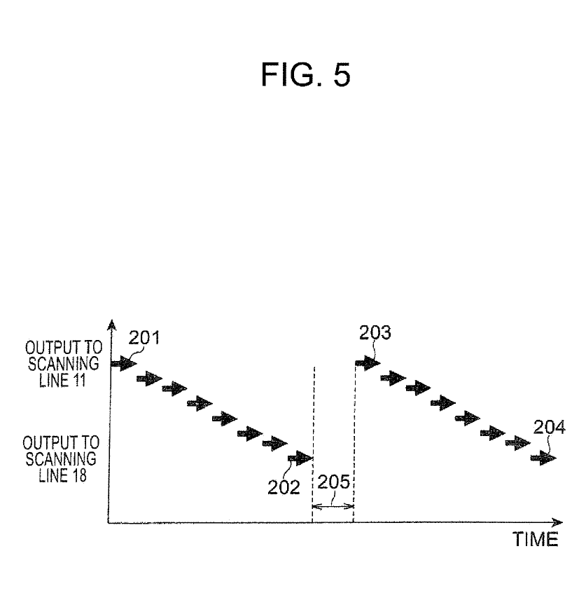

FIG. 4 illustrates an image output method using the liquid crystal display device 102 of a line-scanning type. As shown in FIG. 4, on the screen of the liquid crystal display device 102, data are sequentially written to scanning lines 11-18 in this order (scanning line 11: top scanning line). FIG. 5 is a timing chart corresponding to

FIG. 4. As shown in FIG. 5, data of a frame are sequentially output to the scanning lines 11-18 in this order. Reference numeral 201 denotes a data output time when data is output to the scanning line 11. After the end of a data output time 202 for data output to the scanning line 18 (i.e., completion of the writing of the data of the one frame), a vertical blanking period 205 elapses until a start of writing of data of the next frame. Then, the data of the next frame are sequentially output to the scanning lines 11-18.

As shown in FIG. 3, the liquid crystal shutter controller 103 controls the opening/closing of the liquid crystal shutter L 104 and the liquid crystal shutter R 105 based on a frame control signal 107. The liquid crystal shutter controller 103 opens the liquid crystal shutter R 105 (and closes the liquid crystal shutter L 104) while a right-eye image is displayed on the liquid crystal display device 102, and opens the liquid crystal shutter L 104 (and closes the liquid crystal shutter R 105) while a left-eye image is displayed on the liquid crystal display device 102.

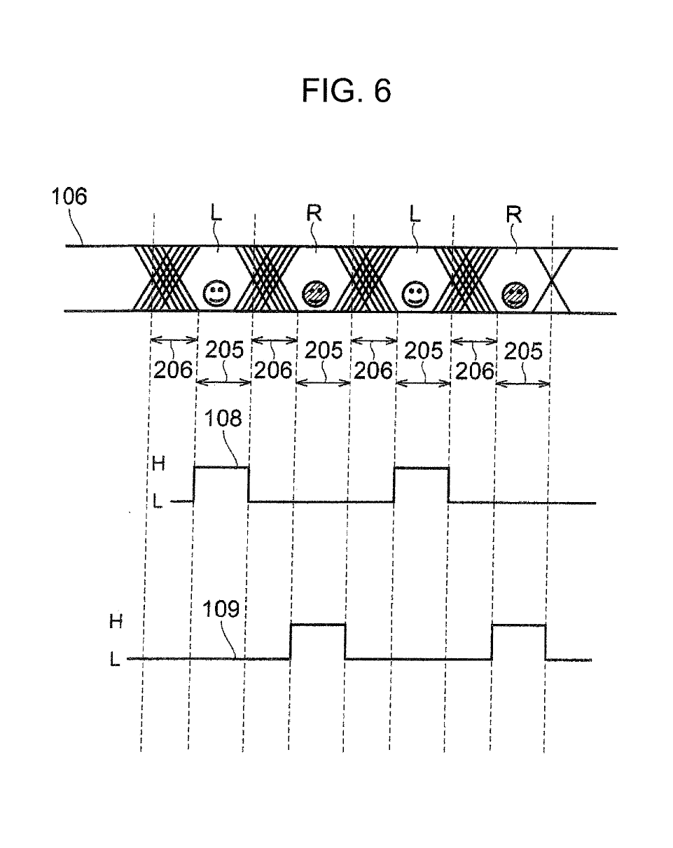

Basically, a stereoscopic image can be displayed and viewed by the control described in the above. However, in liquid crystal display devices, frame images (pictures) are viewed to be overlapped on each other due to an image delay of each time frame, a phenomenon which is specific to liquid crystal display devices and absent from CRT displays. FIG. 6 shows a problem that arises when a liquid crystal display device displays a stereoscopic image by a conventional method. As shown in FIG. 6, a liquid crystal display device having a slow response speed, when switching is made from one frame image (e.g., a left-eye frame image L) to the next frame image (e.g., a right-eye frame image R) in a liquid crystal response time (also called a “response speed”) 206 of the liquid crystal display device, an overlapping period of the two frame images (i.e., a period when picture superimposition is conspicuous) occurs. Therefore, if the left-eye shutter and the right-eye shutter are merely opened alternately in time frames, the eyes of a user receive a displayed image that is a superimposition of a right-eye frame image and a left-eye frame image and the user cannot see a correct stereoscopic image.

One countermeasure is shown in FIG. 6 in which each of the liquid crystal shutter L control signal 108 and the liquid crystal shutter R control signal 109 is given the high level only in time periods excluding the liquid crystal response time 206 and each of the liquid crystal shutter L 104 and the liquid crystal shutter R 105 is opened in corresponding time periods. However, in this case, vertical blanking periods 205 in each of which one frame image is fixed become very short, resulting in a problem that a displayed stereoscopic image is dark over the entire screen and hence is difficult to see.

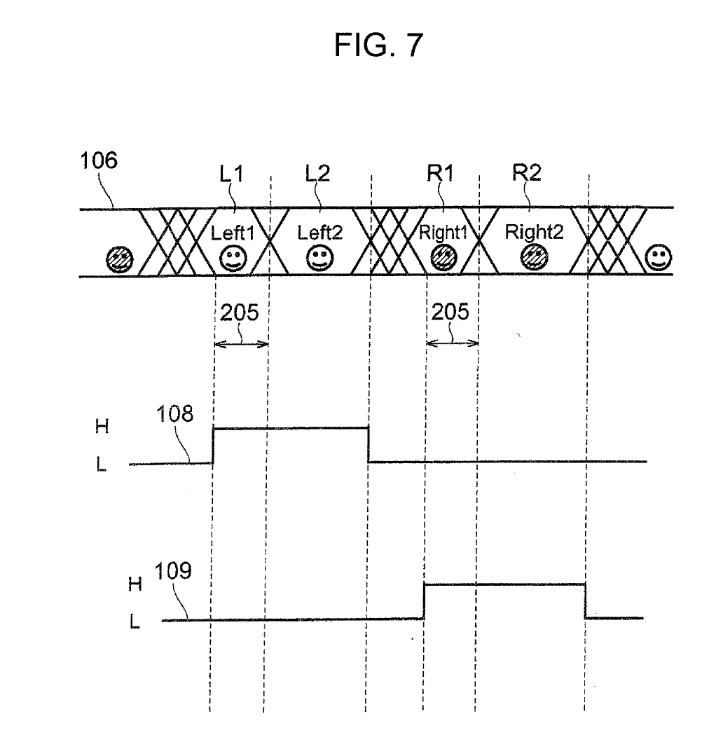

FIG. 7 is a timing chart showing frame data and a liquid shutter control method according to the first embodiment. As shown in FIG. 7, in this embodiment, the liquid crystal display device 102 displays a first left-eye frame L1 and a second left-eye frame L2 of the same frame image sequentially in each time frames for a left-eye image and displays a first right-eye frame R1 and a second right-eye frame R2 of the same frame image sequentially in each time frames for a right-eye image.

Each of the liquid crystal shutter L control signal 108 and the liquid crystal shutter R control signal 109 is given the high level in time periods obtained by excluding the liquid crystal response time 206 from time frames for a left-eye image or a right-eye image and each of the liquid crystal shutter L 104 and the liquid crystal shutter R 105 is opened in corresponding time periods. That is, each of the liquid crystal shutter L control signal 108 and the liquid crystal shutter R control signal 109 is given the high level in time periods each being the sum of the vertical blanking period 205 of a first left-eye frame L1 or a first right-eye frame R1 and the time period of a second left-eye frame L2 or a second right-eye frame R2 and each of the liquid crystal shutter L 104 and the liquid crystal shutter R 105 is opened in corresponding time periods.

In this embodiment, with the above configuration, two frames of the same frame image are displayed sequentially in each of time frames for a left-eye image and a right-eye image, whereby the time when a left-eye frame image or a right-eye frame image is fixed can be elongated. A stereoscopic image displayed can thus be made easy to see. In particular, since first left-eye frames L1, second left-eye frames L2, first right-eye frames R1, and second right-eye frames R2 (frames of each kind) are displayed at a rate of 60 frames/sec or more, a flicker of an image displayed on the liquid crystal display device can be prevented and a stereoscopic image displayed can thus be made even easier to see.

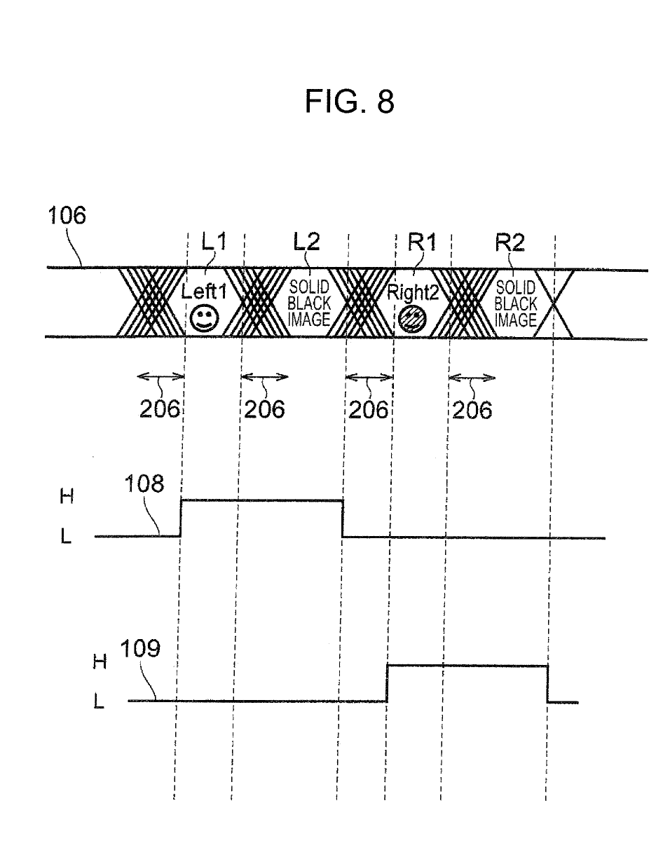

A second embodiment of the invention will be described below. FIG. 8 is a timing chart showing frame data and a liquid shutter control method according to the second embodiment. In this embodiment, the liquid crystal display device 102 displays a first left-eye frame L1 and a second left-eye frame L2 which is a solid black image sequentially in each time frames for a left-eye image and displays a first right-eye frame R1 and a second right-eye frame R2 which is a solid black image sequentially in each time frames for a right-eye image.

As in the first embodiment, each of the liquid crystal shutter L control signal 108 and the liquid crystal shutter

R control signal 109 is given the high level in time periods obtained by excluding the liquid crystal response time 206 from time frames for a left-eye image or a right-eye image and each of the liquid crystal shutter L 104 and the liquid crystal shutter R 105 is opened in corresponding time periods. That is, each of the liquid crystal shutter L control signal 108 and the liquid crystal shutter R control signal 109 is given the high level in periods each being the sum of the vertical blanking period 205 of a first left-eye frame L1 or a first right-eye frame R1 and the period of a second left-eye frame L2 or a second right-eye frame R2 (solid black image period) and each of the liquid crystal shutter L 104 and the liquid crystal shutter R 105 is opened in corresponding time periods.

In this embodiment, with the above configuration, in each of time frames for a left-eye image and a right-eye image, a black-image frame is displayed after display of a left-eye frame image or a right-eye frame image. Since a black-image frame is inserted between a left-eye frame image and a right-eye frame image, there is no time when the left-eye frame image and the right-eye frame image are overlapped on each other, which makes a displayed stereoscopic image easy to see. In addition, since a black-image frame is inserted between a left-eye frame image and a right-eye frame image, a displayed image can be made clearer. The reduction in screen brightness due to the insertion of black-image frames can be compensated for by increasing the light quantity of the backlight of the liquid crystal display device 102.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A stereoscopic image display apparatus, comprising:
a liquid crystal display configured to alternately display a left-eye video and a right-eye video in a time division manner, the liquid crystal display having a liquid crustal response time; and
shutter glasses including a left-eye shutter configured to cover and expose a left eye and a right-eye shutter configured to cover and expose a right eye,
wherein the liquid crystal display
sequentially displays a first left-eye frame and a second left-eye frame that is the same with the first left-eye frame in a first display period, and
sequentially displays a first right-eye frame and a second right-eye frame that is the same with the first right-eye frame in a second display period,
wherein the first display period and the second display period are alternatively repeated,
wherein, within the first display period, the left-eye shutter exposes the left eye except for the liquid crystal response time, and
wherein, within the second display period, the right-eye shutter exposes the right eye except for the liquid crystal response time.

2. The apparatus of claim 1, wherein the liquid crystal display displays each of the first and second left-eye frames and the first and second right-eye frames at a rate of 60 frames per second or more.

3. A method for displaying a stereoscopic image, the method comprising:
sequentially displaying a first left-eye frame and a second left-eye frame that is the same with the first left-eye frame during a first display period;
exposing a left eye of a left-eye shutter during the first display period except during a liquid crystal response time of the first display period;
sequentially displaying a first right-eye frame and a second right-eye frame that is the same with the first right-eye frame during a second display period;
exposing the right-eye shutter during the second display period except during a liquid crystal response time of the second display period; and
wherein the first display period and the second display period are alternatively repeated.

4. The method of claim 3, wherein the liquid crystal display displays each of the first and second left-eye frames and the first and second right-eye frames at a rate of 60 frames per second or more.

5. A method conducted by a liquid crystal display comprising:
alternately displaying a left-eye video and a right-eye video in a time division manner;
sequentially displaying a first left-eye frame and a second left-eye frame that is the same with the first left-eye frame at a time in a first display period after a liquid crystal response time has elapsed and while a left-eye shutter of shutter glasses is configured to be exposed; and
sequentially displaying a first right-eye frame and a second right-eye frame that is the same with the first right-eye frame at a time in a second display period after the liquid crystal response time has elapsed and while a right-eye shutter of the shutter glasses is configured to be exposed.

6. The method of claim 5, wherein each of the first and second left-eye frames and the first and second right-eye frames are displayed at a rate of 60 frames per second or more.
